(19) United States
(12) Patent Application Publication
(10) Pub. No.: US 2005/0264874 A1
(43) Pub. Date: Dec. 1, 2005

(54) Omnidirectional photonic crystal

(76) Inventor: Chung-Hsiang Lin, Taipei City (TW)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 10/852,777

(22) Filed: May 25, 2004

(51) Int. Cl. G02B 5/08

(52) U.S. Cl. 359/359; 359/588

(57) ABSTRACT

An omnidirectional photonic crystal includes a substrate and a periodic dielectric structure that is formed on the substrate and that includes a stack of dielectric units. Each of the dielectric units includes upper and lower dielectric slabs and at least one intermediate dielectric slab sandwiched between the upper and lower dielectric slabs. The periodic dielectric structure introduces an omnidirectional photonic band gap in a given frequency range. The periodic dielectric structure defines a lattice constant a that is equal to the total thickness of each of the dielectric units. The intermediate dielectric slab has a thickness d, the upper dielectric slab has a thickness equal to x(a−d), and the lower dielectric slab has a thickness equal to (1−x) (a−d), where x is a positive number ranging from 0.2 to 0.8.

### BACKGROUND OF THE INVENTION

1. Field of the Invention

This invention relates to an omnidirectional photonic crystal, more particularly to an omnidirectional photonic crystal useful for optical filters.

2. Description of the Related Art

Conventional optical filters, such as long-wavelength pass filters and short-wavelength pass filters, include a multi-layered dielectric structure that is capable of rejecting radiation falling outside of the frequency range of interest from passing therethrough. However, the conventional optical filters are disadvantageous in that when the incident angle of the incoming light is broad, undesired frequencies outside the frequency range of interest also pass through the conventional optical filters.

U.S. Pat. No. 6,130,780 discloses a highly omnidirectional reflector made from an omnidirectional photonic crystal that includes a periodic photonic structure with a surface and a refractive index variation along a direction perpendicular to the surface and that exhibits complete reflection of radiation in a given frequency range for all incident angles and polarizations.

FIG. 1 illustrates the conventional omnidirectional photonic crystal that includes a substrate 20 and a periodic dielectric structure 200 that is formed on the substrate 20 and that includes a stack of dielectric units 2 that are stacked in a y-direction. Each of the dielectric units 2 includes first and second dielectric slabs 21, 22 stacked one above the other and made from different dielectric materials, which have different refractive indices. The periodic dielectric structure 200 introduces an omnidirectional photonic band gap (see FIG. 2) in a given frequency range such that radiation at the frequency range for all incident angles and polarizations can be totally reflected by the omnidirectional photonic crystal. The first dielectric slab 21 of each of the dielectric units 2 has a fixed thickness d₁, whereas the second dielectric slab 22 of each of the dielectric units 2 has a fixed thickness d₂. The periodic dielectric structure 200 defines a lattice constant a that is equal to the total thickness of each of the dielectric units 2, i.e., equal to d₁+d₂.

Although the aforesaid omnidirectional photonic crystal is useful as an optical reflector, it also exhibits a high transmittance for frequencies outside of the aforesaid frequency range of interest for all incident angles and polarizations, and is an ideal candidate for use as an optical filter. However, there is still room for improvement in the transmittance of the conventional omnidirectional photonic crystal used as an optical filter in a given frequency range.

The entire disclosure of U.S. Pat. No. 6,130,780 is hereby incorporated herein by reference.

### SUMMARY OF THE INVENTION

The object of the present invention is to provide an omnidirectional photonic crystal that is useful for optical filters and that is capable of overcoming the aforesaid drawbacks associated with the prior art.

According to this invention, an omnidirectional photonic crystal comprises: a substrate; and a periodic dielectric structure that is formed on the substrate and that includes a stack of dielectric units. Each of the dielectric units includes upper and lower dielectric slabs and at least one intermediate dielectric slab sandwiched between the upper and lower dielectric slabs. The periodic dielectric structure introduces an omnidirectional photonic band gap in a given frequency range such that radiation at the frequency range for all incident angles and polarizations can be totally reflected by the omnidirectional photonic crystal. The upper and lower dielectric slabs of each of the dielectric units are made from a first dielectric material. The intermediate dielectric slab of each of the dielectric units is made from a second dielectric material that has a refractive index smaller than that of the first dielectric material. The periodic dielectric structure defines a lattice constant a that is equal to the total thickness of each of the dielectric units. The intermediate dielectric slab of each of the dielectric units has a thickness d, the upper dielectric slab of each of the dielectric units has a thickness equal to x(a−d), and the lower dielectric slab of each of the dielectric units has a thickness equal to (1−x) (a−d), where x is a positive number ranging from 0.2 to 0.8.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a periodic dielectric structure of a conventional omnidirectinal photonic crystal;

FIG. 2 is a plot showing the presence of an omnidirectional photonic band gap in the dispersion relation of the guided modes in a photonic band structure of the omnidirectional photonic crystal of FIG. 1;

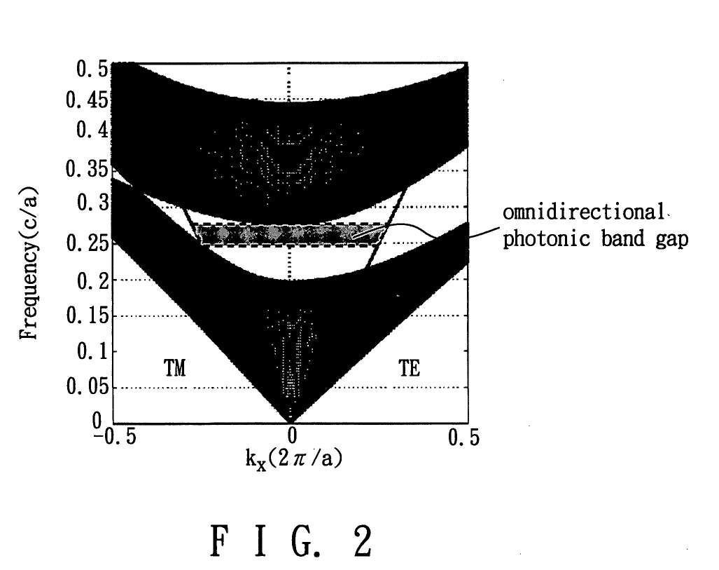

FIG. 3 is a schematic view of the preferred embodiment of an omnidirectinal photonic crystal according to this invention, which has a lattice shifted from the omnidirectinal photonic crystal of FIG. 1;

FIG. 4 is a contour plot showing variation of transmittance of the preferred embodiment with a shifting factor x for the substrate having a refractive index equal to 1.0;

FIG. 5 is a contour plot showing variation of transmittance of the preferred embodiment with the shifting factor x for the substrate having a refractive index equal to 1.5; and

FIG. 6 is a plot showing comparison of the average reflectance among the omnidirectional photonic crystal of the preferred embodiment, the conventional photonic crystal of FIG. 1, and the omnidirectional photonic crystal with the lattice being shifted in contrast to the preferred embodiment.

### DETAILED DESCRIPTION OF THE PREFERRED EMBODIMENT

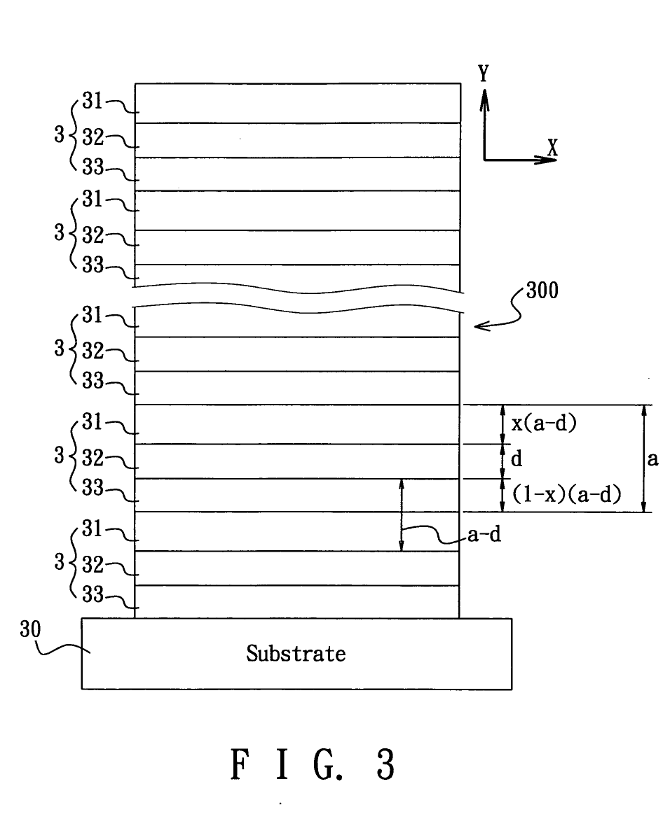

FIG. 3 illustrates the preferred embodiment of an omnidirectional photonic crystal useful for optical filters according to the present invention. The periodic dielectric structure of the omnidirectional photonic crystal of this invention is similar to that of the conventional omnidirectional photonic crystal, except that the lattice of the dielectric structure is shifted in the y-direction so as to divide the first dielectric slab, which has a higher refractive index than that of the second dielectric slab, into two parts such that the new lattice will be viewed as having three dielectric slabs, i.e., the two parts plus the second dielectric slab, as will be described in the following.

The omnidirectional photonic crystal of this invention includes: a substrate 30 made from a material with a refractive index (n₃); and a periodic dielectric structure 300 that is formed on the substrate 30 and that includes a stack of dielectric units 3. Each of the dielectric units 3 includes upper and lower dielectric slabs 31, 33 and at least one intermediate dielectric slab 32 sandwiched between the upper and lower dielectric slabs 31, 33. The periodic dielectric structure 300 introduces an omnidirectional photonic band gap in a given frequency range such that radiation at the frequency range for all incident angles and polarizations can be totally reflected by the omnidirectional photonic crystal. The upper and lower dielectric slabs 31, 33 of each of the dielectric units 3 are made from a first dielectric material. The intermediate dielectric slab 32 of each of the dielectric units 3 is made from a second dielectric material that has a refractive index (n₂) smaller than the refractive index (n₁) of the first dielectric material. The periodic dielectric structure 300 defines a lattice constant a that is equal to the total thickness of each of the dielectric units 3. The intermediate dielectric slab 32 of each of the dielectric units 3 has a thickness d, the upper dielectric slab 31 of each of the dielectric units 3 has a thickness equal to x(a−d), and the lower dielectric slab 33 of each of the dielectric units 3 has a thickness equal to (1−x) (a−d), where x is a positive number ranging from 0.2 to 0.8.

Preferably, the first dielectric material is made from a compound selected from the group consisting of TiO₂, Ta₂O₅, ZrO₂, ZnO, Nd₂O₃, Nb₂O₅, In₂O₃, SnO₂, Sb₂O₃, HfO₂, CeO₂, and ZnS, and the second dielectric material is made from a compound selected from the group consisting of SiO₂, Al₂O₃, MgO, La₂O₃, Yb₂O₃, Y₂O₃, Sc₂O₃, WO₃, LiF, NaF, MgF₂, CaF₂, SrF₂, BaF₂, AlF₃, LaF₃, NdF₃, YF₃, and CeF₃.

Preferably, x ranges from 0.4 to 0.6, and most preferably, x is equal to 0.5.

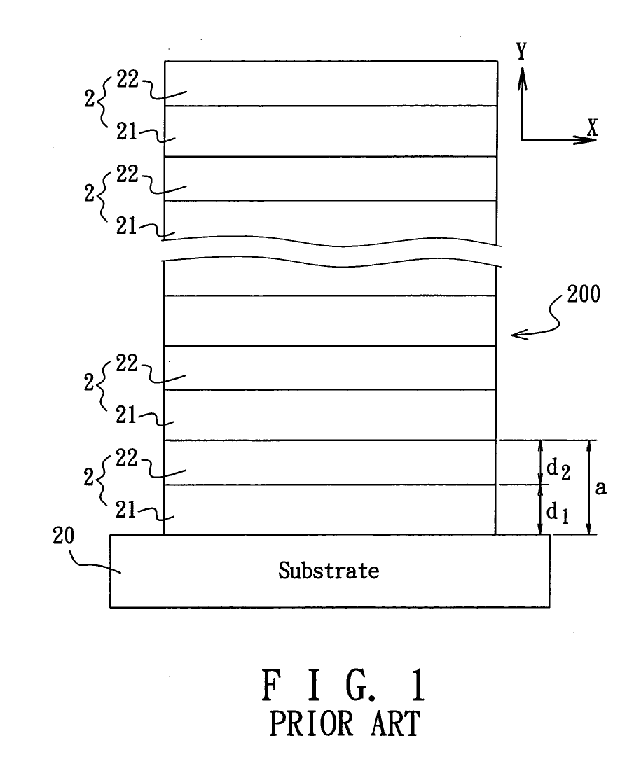

As a result of the lattice shifting in the y-direction, the first dielectric slab 21 of the conventional omnidirectional photonic crystal of FIG. 1 can be divided into an adjacent pair of the upper and lower dielectric slabs 31, 33 shown in FIG. 3. When x is equal to zero, i.e., there is no lattice shifting on the periodic dielectric structure 200 of the omnidirectional photonic crystal of FIG. 1, the dielectric structure 300 of FIG. 3 will be the same as that of the dielectric structure 200 of FIG. 1.

The present invention will now be described in more detail with reference to the following Examples.

### EXAMPLE 1

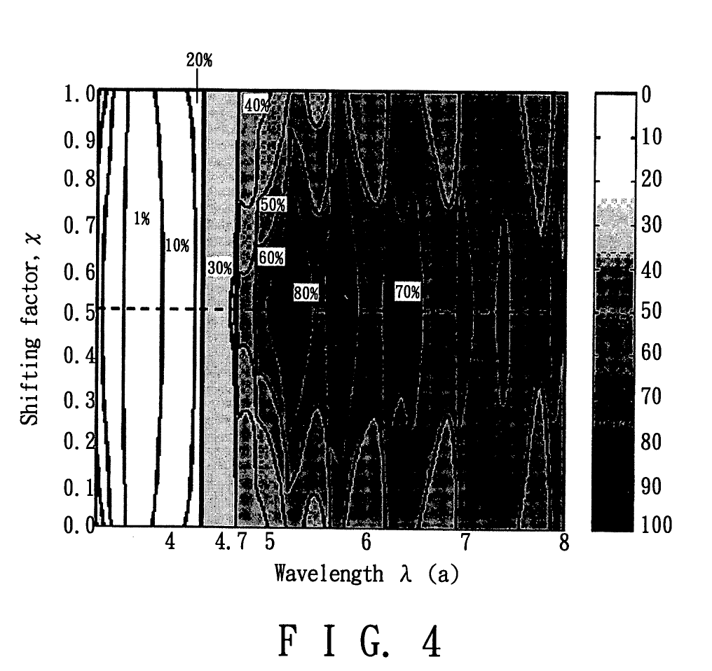

The periodic dielectric structure 300 of the omnidirectional photonic crystal of this Example includes fourteen stacked dielectric units 3, each including the upper and lower dielectric slabs 31, 33 and one intermediate dielectric slab 32, with n₁=2.7 (TiO₂), n₂=1.5 (SiO₂), n₃=1.0 (substrate 30), d=0.5a, and x=0.5, and introduces an omnidirectional photonic band gap in a frequency range between 0.248c/a and 0.276c/a, where c is the speed of light, or in a wavelength range between 3.6a and 4.0a. Note that the width and the location (i.e., the frequency range) of the omnidirectional photonic band gap will not vary with x. Transmittance of the omnidirectional photonic crystal of this Example in a given range of wavelength λ is calculated for different values of x. The results are shown in FIG. 4.

When the wavelength λ is less than about 4.7a (see FIG. 4), the transmittance of the omnidirectional photonic crystal almost remains the same and does not change with the shifting factor x. On the other hand, when λ is greater than about 4.7a, the transmittance of the omnidirectional photonic crystal changes considerably with the shifting factor x. The highest transmittance for all the wavelength greater than about 4.7a occurs at x=0.5. In the wavelength range greater than about 4.7a, the transmittance of the omnidirectional photonic crystal increases when x increases from zero to 0.5 or when x decreases from 1.0 to 0.5.

### EXAMPLE 2

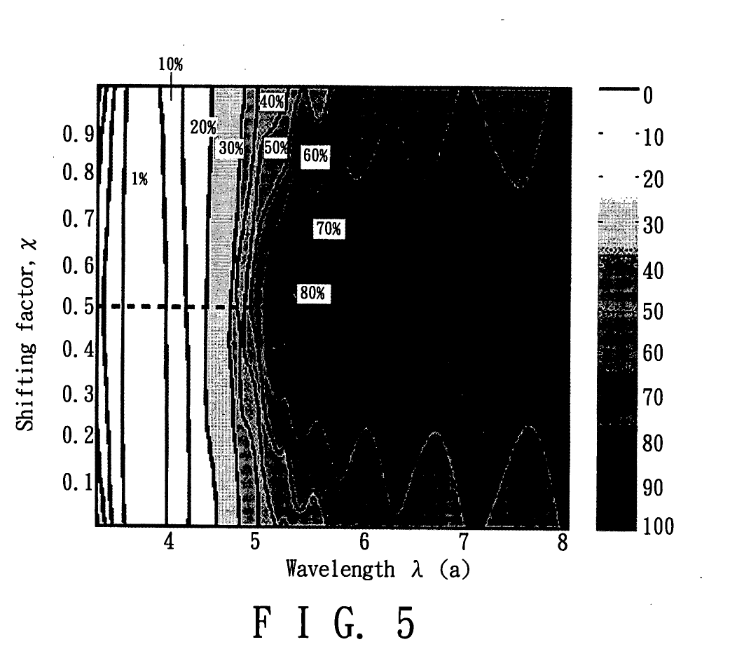

The periodic dielectric structure 300 of the omnidirectional photonic crystal of this Example differs from the previous Example in that n₃=1.5. Transmittance of the omnidirectional photonic crystal of this Example in a given range of wavelength λ is calculated for different values of x. The results are shown in FIG. 5.

The behavior of the variation of transmittance with x for the omnidirectional photonic crystal of this example is similar to that of the previous Example. The highest transmittance for all the wavelength greater than about 5.0a occurs at x=0.5.

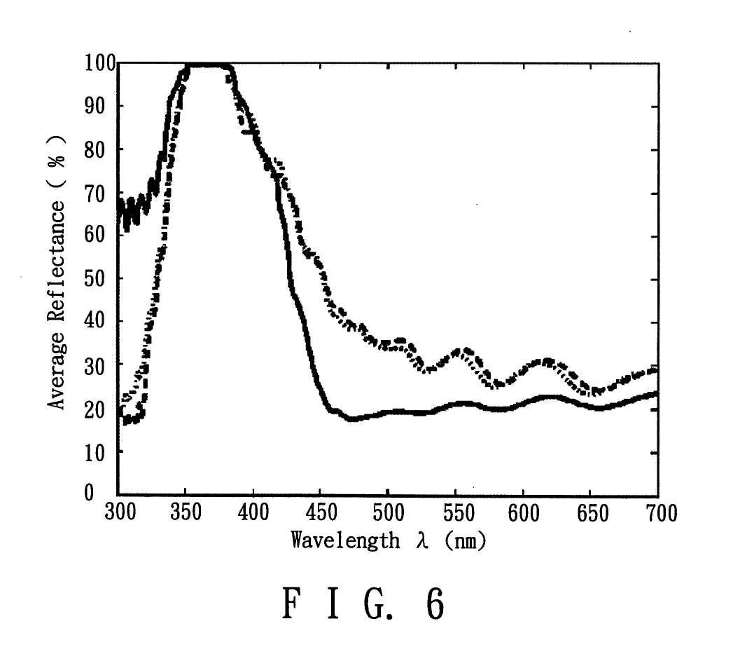

FIG. 6 is a plot showing comparison of the average reflectance (an inversion of the transmittance) among the omnidirectional photonic crystal (solid line) of the preferred embodiment with x=0.5, a=102 nm, and d=44 nm (the intermediate dielectric slab 32 is SiO₂, and the upper and lower dielectric slabs 31, 32 are TiO₂), the conventional omnidirectional photonic crystal of FIG. 1 (dotted line, x=0), and the omnidirectional photonic crystal (dashline) with x=0.5, a=102 nm, d=58 nm, and in contrast to the preferred embodiment, the intermediate dielectric slab 32 is TiO₂, and the upper and lower dielectric slabs 31, 32 are SiO₂. The results show that the behavior of the transmittance for the omnidirectional photonic crystal with the lattice being shifted in contrast to the preferred embodiment is almost identical to the conventional omnidirectional photonic crystal of FIG. 1, i.e., no improvement in transmittance is achieved.

By shifting the lattice of a conventional omnidirectional photonic crystal as done in the preferred embodiment of this invention, the transmittance of the omnidirectional photonic crystal in a given frequency range can be significantly improved.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. An omnidirectional photonic crystal comprising:
a substrate; and
a periodic dielectric structure that is formed on said substrate and that includes a stack of dielectric units, each of said dielectric units including upper and lower dielectric slabs and at least one intermediate dielectric slab sandwiched between said upper and lower dielectric slabs, said periodic dielectric structure introducing an omnidirectional photonic bandgap in a given frequency range such that radiation at said frequency range for all incident angles and polarizations can be totally reflected by said omnidirectional photonic crystal, said upper and lower dielectric slabs of each of said dielectric units being made from a first dielectric material, said intermediate dielectric slab of each of said dielectric units being made from a second dielectric material that has a refractive index smaller than that of said first dielectric material;
wherein said periodic dielectric structure defines a lattice constant a that is equal to the total thickness of each of said dielectric units; and
wherein said intermediate dielectric slab of each of said dielectric units has a thickness d, said upper dielectric slab of each of said dielectric units has a thickness equal to x(a−d), and said lower dielectric slab of each of said dielectric units has a thickness equal to (1−x) (a−d), where x is a positive number ranging from 0.2 to 0.8.

2. The omnidirectional photonic crystal of claim 1, wherein x ranges from 0.4 to 0.6.

3. The omnidirectional photonic crystal of claim 1, wherein said first dielectric material is made from a compound selected from the group consisting of TiO₂, Ta₂O₅, ZrO₂, ZnO, Nd₂O₃, Nb₂O₅, In₂O₃, SnO₂, Sb₂O₃, HfO₂, CeO₂, and ZnS, and the second dielectric material is made from a compound selected from the group consisting of SiO₂, Al₂O₃, MgO, La₂O₃, Yb₂O₃, Y₂O₃, Sc₂O₃, WO₃, LiF, NaF, MgF₂, CaF₂, SrF₂, BaF₂, AlF₃, LaF₃, NdF₃, YF₃, and CeF₃.

4. An optical filter comprising:
an omnidirectional photonic crystal comprising
a substrate, and
a periodic dielectric structure that is formed on said substrate and that includes a stack of dielectric units, each of said dielectric units including upper and lower dielectric slabs and at least one intermediate dielectric slab sandwiched between said upper and lower dielectric slabs, said periodic dielectric structure introducing an omnidirectional photonic band gap in a given frequency range such that radiation at said frequency range for all incident angles and polarizations can be totally reflected by said omnidirectional photonic crystal, said upper and lower dielectric slabs of each of said dielectric units being made from a first dielectric material, said intermediate dielectric slab of each of said dielectric units being made from a second dielectric material that has a refractive index smaller than that of said first dielectric material;
wherein said periodic dielectric structure defines a lattice constant a that is equal to the total thickness of each of said dielectric units; and
wherein said intermediate dielectric slab of each of said dielectric units has a thickness d, said upper dielectric slab of each of said dielectric units has a thickness equal to x(a−d), and said lower dielectric slab of each of said dielectric units has a thickness equal to (1−x) (a−d), where x is a positive number ranging from 0.2 to 0.8, so that radiation outside of said frequency range for all incident angles and polarizations can effectively pass through said omnidirectional photonic crystal.

5. The optical filter of claim 4, wherein x ranges from 0.4 to 0.6.

6. The optical filter of claim 4, wherein said first dielectric material is made from a compound selected from the group consisting of TiO₂, Ta₂O₅, ZrO₂, ZnO, Nd₂O₃, Nb₂O₅, In₂O₃, SnO₂, Sb₂O₃, HfO₂, CeO₂, and ZnS, and the second dielectric material is made from a compound selected from the group consisting of SiO₂, Al₂O₃, MgO, La₂O₃, Yb₂O₃, Y₂O₃, Sc₂O₃, WO₃, LiF, NaF, MgF₂, CaF₂, SrF₂, BaF₂, AlF₃, LaF₃, NdF₃, YF₃, and CeF₃.
